(19) United States
(12) Patent Application Publication
(10) Pub. No.: US 2010/0087946 A1
(43) Pub. Date: Apr. 8, 2010

(54) Methods for Automated Fabrication and Dispense of Diffusion Dressings for Use in Tissue Treatment

(76) Inventors: Olivier B. Postel, Redwood City, CA (US); Amie B. Franklin, Mill Valley, CA (US)

Correspondence Address: CENTRAL COAST PATENT AGENCY, INC, 3 HANGAR WAY SUITE D, WATSONVILLE, CA, 95076, US

(21) Appl. No.: 12/264,683

(22) Filed: Nov. 4, 2008

Related U.S. Application Data
(60) Provisional application No. 61/102,166, filed on Oct. 2, 2008.

(51) Int. Cl. G05B 19/18; G05B 19/00

(52) U.S. Cl. 700/117; 700/275

(57) ABSTRACT

A method supported by machine automation is provided for fulfilling a request for a diffusion dressing comprising the steps (a) translating the request into a set of machine readable instructions the translation performed by the machine receiving the request, (b) equating the commands in the machine instruction set to a build sequence known to the machine that received the request, (c) executing the build sequence to create the diffusion dressing, and (d) dispensing the diffusion dressing from the machine.

### CROSS-REFERENCE TO RELATED APPLICATIONS

The present application claims priority to Provisional patent application No. 61/102,166, filed Oct. 2, 2008, the disclosure of which is included herein in its entirety at least by reference.

### BACKGROUND OF THE INVENTION

1. Field of the Invention

The present invention is in the field of process automation and pertains particularly to processes enabled by automated machine for onsite preparation and dispensing of medically therapeutic diffusion dressings.

2. Discussion of the State of the Art

In the medical field it is often required to treat tissue of patients in a manner which requires an extended period of bandaging or covering with medication diffusing patches or like devices that work to keep tissue moist, promote healing, to prevent maceration, possible infection, or to prevent any jolting or other physical disruption of a particular tissue area.

A diffusion dressing for treating tissue is typically charged with some therapeutic agent that is expelled from the device through a diffusion process. Most such diffusion dressings employ gasses or other therapeutic agents that are infused into a reservoir in the device, the gases or other agents being diffused into a tissue area through a special diffusion layer of the device. Diffusion layers for allowing the agent to treat the wound and adhesive layers for application of the dressing over a tissue wound are typically a part of such apparatus.

Much manual work is required to create a diffusion dressing from raw materials. The material for each layer of the dressing has to be selected and cut, sealing of edges must be performed, application of adhesive for tissue adherence, device charging, device packaging, etc. The type of diffusion dressing architecture and what therapeutic agent it will accommodate depends entirely on the type of tissue problem the dressing is intended to serve in a therapeutic sense. Moreover, size and shape of the dressing may depend on physical aspects of the body portion or body part of a patient affected by the tissue problem and the actual size and scope of the tissue problem needing treatment.

It would be desirable to automate much of the processing devoted to creating and preparing a diffusion dressing for use on a patient. As well, it would be desirable if such an automated process were made flexible enough to be carried out differently according to specific process instruction variations. It would further be desirable if a standard automated process could be ordered onsite resulting in timely dispense of completed diffusion dressings to practitioners requiring them for use on patients. Therefore, what is clearly needed are process automations supported by machine principle for assembling a diffusion dressing and dispensing the dressing onsite for use in tissue treatment.

### SUMMARY OF THE INVENTION

The problem stated above is that automation for creating diffusion dressings for treating patient wounds is desirable but may of the conventional means for creating these devices are manual and not automated. The inventors therefore considered functional elements of diffusion dressing and machinery looking for machine elements that exhibit mechanization that could be adapted to build diffusion dressings from available raw materials. Every diffusion dressing diffuses some form of a therapeutic agent into a tissue wound to promote localized healing. The dressing architecture includes a diffusion layer through which the agent passes into the wound tissue. Additional components of a diffusion dressing may include material layers that may be impermeable or permeable to the therapeutic agent, dressing material, adhesive borders, and one or more reservoirs formed by sealing the architecture.

The present inventor realized in an inventive moment that if, at the point of need, diffusion dressings could be fabricated and dispensed by automated machine, significant time savings might result. The inventor therefore conceived unique methods supported by machine principle in a powered system for preparing and dispensing diffusion dressings from raw available materials. A significant reduction in time from the point of diagnosis of a need for a dressing and the actual point in time the dressing is applied is realized with no degradation of quality of the dressing incurred.

Accordingly, in one aspect of the invention, a method supported by machine automation is provided for fulfilling a request for a diffusion dressing comprising the steps (a) translating the request into a set of machine readable instructions the translation performed by the machine receiving the request, (b) equating the commands in the machine instruction set to a build sequence known to the machine that received the request, (c) executing the build sequence to create the diffusion dressing, and (d) dispensing the diffusion dressing from the machine.

In one aspect the request is entered into the machine as digital input. In one embodiment the diffusion dressing includes a top layer, a reservoir, and a diffusion layer the reservoir located between the layers. In one aspect the request is received through a keyboard and monitor interface. In one aspect in step (a) the machine-readable instructions include X and Y dimensioning.

In one aspect of the method in step (b) the build sequence includes a step for cutting a length X of dressing from a roll of dressing of width Y, X and Y specified in the request. In one aspect in step (b) the build sequence includes a step for packaging the diffusion dressing. In another aspect in step (b) the build sequence includes a step for filling the diffusion dressing with a therapeutic agent. In one aspect steps (c) and (d) are repeated in sequence for a number of diffusion devices ordered of the same type and properties. In still another aspect in step (b) the build sequence includes a step for applying an adhesive border. In a variation of the aspect where multiple repetition of steps (c) and (d) occur to produce multiple dressings the dispensed diffusion dressings are linked together by a perforated section.

According to one embodiment of the invention a computerized system is provided for preparing and dispensing diffusion dressings according to instruction data input into the system. The system includes a computerized platform for inputting information, one or more material stations for housing raw materials, at least one set of mechanized rollers for advancing material, at least one set of material cutters for cutting material, a mechanized edge sealer for sealing material edges, and an externally accessible repository for dispensing finished dressings.

In one embodiment the computerized platform includes a graphics monitor, a keyboard, and a processing component. In another embodiment the computerized platform includes an optical character recognition (OCR) scanner or a bar code reader. In one embodiment the one or more material stations is an axle supporting a roll of material. In another embodiment the one or more material stations is a bin containing material stacked in folds.

In one embodiment the system further includes at least one delivery system and reservoir for storing and delivering a therapeutic agent. In a variation of this embodiment the reservoir is a pressurized tank and the therapeutic agent is a gas. In one embodiment the delivery system includes a pump and the therapeutic agent is a liquid.

In one embodiment the system further includes a mechanized cartridge for installing charge ports. In one embodiment the system further includes at least one mechanized tape dispenser for applying an adhesive border to the diffusion device. In one embodiment the edge sealer operates by heating material edges to form the seal. In another embodiment the edge sealer dispenses epoxy or adhesive strip to seal the edge.

In one embodiment the system further includes a mechanized dressing packager for hermetically packaging the dressing. In a variation of this embodiment the packager places the device on a packing layer of a size footprint larger than the footprint of the dressing and an overlays the dressing with another packing layer of similar dimension and seals the layers together peripherally. In another variation the packager places the dressing into a pre-prepared pouch and then seats the pouch.

In another aspect of the invention, a method is provided for preparation of an empty diffusion dressing comprising the steps (a) manually cutting or shaping a diffusion dressing from dimensionally larger stock, and (b) using automated machine principles, tailoring properties of diffusion device according to need.

In a further aspect, a system is provided for preparing an empty diffusion device cut or otherwise shaped to a finish size comprising a mechanized conveyor to accept at an input port and then dispense into an output tray customized dressings, a computerized data entry interface including a form or template for entering packaging, adhesive, and therapeutic agent parameters, a station including delivery system for charging the diffusion dressing with a therapeutic agent, a station including an adhesive applicator for applying adhesive to the diffusion dressing, and a station including a packaging aim for packaging the diffusion device into a sterile pouch for transport.

### BRIEF DESCRIPTION OF THE DRAWING FIGURES

FIG. 1 is a process flow chart illustrating steps for obtaining a diffusion dressing on demand by interacting with an automated machine according to an embodiment of the present invention.

FIG. 2 is a perspective view of a diffusion dressing machine and a connected data input terminal or station.

FIG. 3 is a block diagram illustrating logical machine components for fabricating a diffusion dressing according to an embodiment of the invention.

FIG. 4 is a process flow chart illustrating steps for building and dispensing a diffusion device according to another embodiment of the present invention.

FIG. 5 is a block diagram illustrating logical machine components for fabricating a diffusion dressing according to another embodiment of the invention.

FIG. 6A is a block diagram logically illustrating a single manually operated dressing dispenser 600 according to another embodiment of the present invention.

FIG. 6B is a block diagram logically illustrating an automated charging and sealing station 608 for finishing a diffusion dressing cut from the dispenser of FIG. 6B.

### DETAILED DESCRIPTION

The inventor provides methods and apparatus for assembling diffusion dressings and in some cases charging such dressings with a therapeutic agent and packaging such dressings for sterile transportation according to instruction provided onsite and using automation and machine principles. The invention is described in various embodiments incorporated into in the following specification.

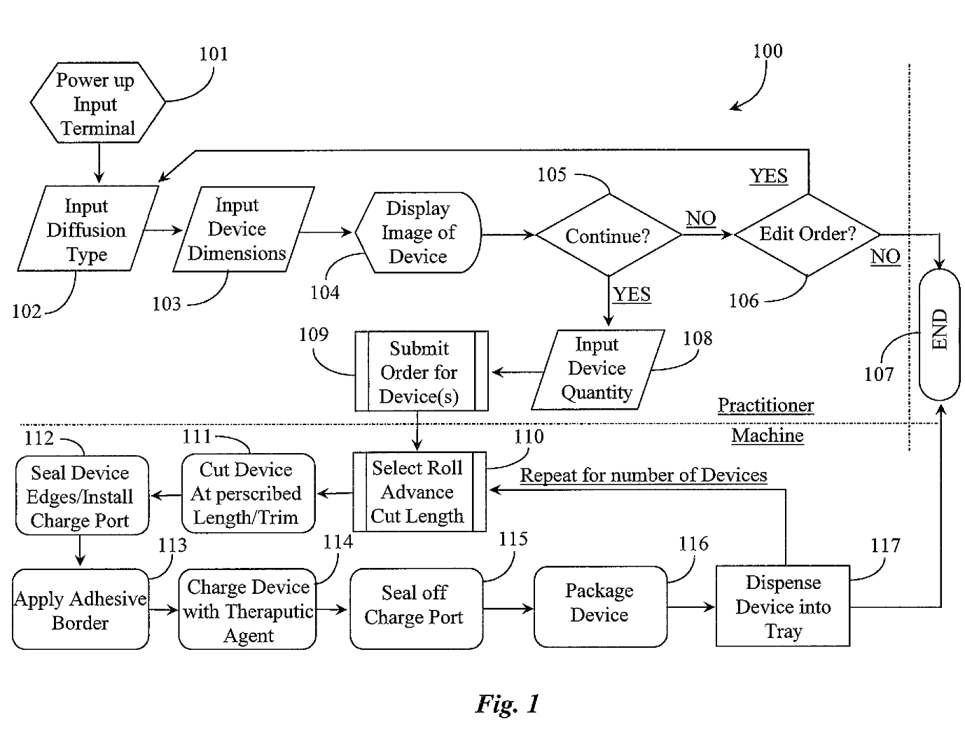

FIG. 1 is a process flow chart illustrating steps 100 for obtaining a diffusion dressing on demand by interacting with an automated machine according to an embodiment of the present invention. At step 101 a user, for example, a nurse or other authorized medical practitioner begins interaction by powering up an input terminal that may be part of or connected to an automated machine. The input terminal may be a computerized terminal having a data input mechanism like a keyboard or keypad and a computer display monitor for visual display of information. Other types of data input mechanisms may be provided and adapted to accept input from a user such as an optical character recognition (OCR) scanner that may accept a written instruction or machine readable code. The terminal of step 101 may also include a combination of data input mechanisms adapted for the purpose of accepting instruction primarily for fabrication and dispense of a diffusion dressing.

At step 102 the user may input the type of diffusion dressing required according to some menu of available dressing types. Labels may be provided to identify the type of dressing. Types of dressings may depend in part of the type of wound that a dressing is used on. This consideration may also determine which of more than one available therapeutic agent might be used to charge the diffusion dressing. Dressing “type” labels may also dictate the architecture of the dressing pertaining to the number and order of dressing layers, and so on.

A machine adapted to prepare and dispense diffusion devices may have one or more rolls of diffusion dressing architecture loaded in a prefab state as available material. One roll may contain one “type” of dressing while another roll may contain another “type” of dressing. Dressing materials may also be loaded in containers adapted to hold to linear dressing architecture in multiple folds rather than wrapped around an axle in a roll. In this example, imputing the diffusion dressing “type” at step 102 enables the machine to select which diffusion dressing architecture to use whether it is pre-loaded in the machine on a roll or in a container. In either case automated feed controls enable advancement of materials for use in fabricating a diffusion device. Such a machine is able to translate a request into a set of machine readable instructions. The request is typically digital input to the system and can be written coded or typed into the system. A logic module may be provided in the machine to equate the commands in the machine instruction set to a build sequence known to the machine. With some standardization there may be one or several different build sequences that the machine is capable of. Of course the correct build sequence is executed and the finished product is dispensed from the machine after it is fabricated.

At step 103 the user may input custom device dimensions that dictate the actual size (length and width) of the diffusion dressing to be fabricated. In one embodiment, the width of diffusion dressings is static and only the length of a device may be ordered. For example a roll of material comprising multiple layers may be pre-sealed along the linear edges defining a static width of the device that comes off of that particular roll. In another embodiment both length and width may be ordered as long as the specified width is smaller that the width of the pre-loaded dressing materials on a roll or in a container in the machine.

At step 104 the image of the diffusion device as ordered may be displayed on the monitor of the input terminal so that the user may see what the finished device will look like. Such an image may be manipulated in one embodiment to make changes in length, width or in some cases shape of the device using a computer graphics input device like a mouse, stylus, or a touchpad. There may be more input parameters than are illustrated in this process without departing from the spirit and scope of the present invention. The exact parameters input into an automated machine through an input terminal may vary according to the level of automation supported and the fabrication capabilities of the machine itself. In one embodiment determining type of diffusion device specifies more than one possible therapeutic agent that can be used to charge the device. Therefore an input parameter or step might be to select a therapeutic agent. Other similar variations in the process may occur.

At step 105 the user may make a determination as to continuing with the present order or not. At display the user may not like the end result and may decide not to continue with the current order at step 105. At step 106 an option for editing the input order parameters may be provided. If the user decides to modify the order then the process may loop back to step 102 so the user may make required changes or edits. At step 106 the user may decide not to edit the existing order and may end the current process at step 107 without completing the order, in effect, canceling the order.

At step 105 the user may decide to continue with the current order. In one embodiment the supporting machine may be adapted to produce ordered quantities of a same dimensioned diffusion device. Therefore at step 108 the user may input the exact number of diffusion dressings required in one order. In one embodiment a user may specify more than one specific type and quantity of diffusion dressing before confirming or submitting the order. At step 109 the user may submit an order for one or more diffusion dressings of one or more types representing the last input human step before the machine takes over the process. The division line in the process divides the steps of the process into “practitioner” initiated steps 101-109 and machine initiated steps beginning at step 110.

At step 110 the machine selects a roll or container hosting the linear diffusion dressing architecture and causes the material to advance or feed out to a specified cut length. Feeding the material may be accomplished using automated machine principles known to and available to the inventor such as by automated rollers for example. At step 111 the machine may cut the diffusion device off of the roll or container at the prescribed cut length input by the user during step 103. One or more cutting blades may be provided and adapted for the purpose. In one embodiment the cutting blade or blades are used to cut the length of the device, the width being static and prefabricated. In one embodiment the same or a different blade or set of blades may be used to trim the width of the device to a prescribed width as well as length.

In this process the dressing architecture hosted on a roll or in a container within the machine is void of any therapeutic agent and consists only of the layers of the device typically sealed along the linear edges of the architecture. At step 112 the edges created by the cutting of step 111 are sealed. The leading edge of the roll or container of material is sealed and the trailing edge of the diffusion dressing is sealed. If the device is cut to a width dimension then the edge or edges left after cutting (trim) are likewise sealed. Therefore a sealed device is one that is sealed completely around the peripheral border of the device.

Sealing an edge of a diffusion device may be accomplished by clamping the edge and applying heat to affect a material-to material seal. In one embodiment an adhesive border or edging material is applied along an edge by automated dispensing of the material along the edge and then clamping the border to the edge material and cutting the adhesive border at the end of the device edge. In one embodiment, the adhesive can be a single piece applied over the entire dressing surface area with dimension larger than the actual dressing. In one embodiment a viscous bead of sealant material may be applied along device edges to seal the edges of the device. A combination of techniques may be used such as application of a bead of sealant followed by application of heat to cure the bead into a hermetic seal.

Sealant may be contained in a reservoir within the machine and may be discharged by an automated stylus-driven delivery system. Sealant material may be provided as a solid rod similar to a welding rod whereby the tip is heated along the edge of the material to provide the sealant. In still another embodiment a sealant is not required because the upper most and lowermost device layers may be caused to form a seal by heating the edges of the device and pressing them together. Layers that are sealed together may include polymer-based films or materials.

At step 112 the machine may also install a port to the diffusion dressing through which the dressing may be charged or filled with a therapeutic agent. A port may comprise a resilient annular structure formed to and protruding up from an adhesive pad. Such a port may be stamped onto the diffusion device by a cartridge gun adapted to dispense one port at each stamping motion. The adhesive on the interfacing surface of the port pad adheres to the top layer of the diffusion dressing at the same location on each dressing.

At step 113 an adhesive border film or strip may be applied to the perimeter of the diffusion dressing to enable the dressing to be adhered to the skin of a patient. An adhesive border may be dispensed from a roll of adhesive tape and applied by a set of rollers. A cutting blade may be provided to cut the tape at an end point on the corner of the device before a next length of tape is applied. To tape 4 sides of a diffusion device 4 passes and 4 cuts may be made on the device.

In one embodiment adhesive border is already pre-installed on the linear edges of the diffusion material hosted on a roll or in a container within the machine and adhesive edging is applied only to the leading and trailing edges of a diffusion dressing cut from a roll or contained material at step 113. In one embodiment the adhesive tape is double sided and has a peel-off layer on the side that interfaces with a patient's skin. In this way a practitioner may apply the device to the skin after peeling off the protective film revealing the adhesive. It is noted herein that other peel-off protective layers may be provided in a diffusion device without departing from the spirit and scope of the invention such as a peel-off layer that prevents therapeutic agent from escaping the device through a diffusion layer for example.

At step 114 the diffusion dressing may be charged or filled with a therapeutic agent. The agent provided may be one that was selected by the user or one that was inferred through device “type” selection by the user. The therapeutic agent may be a gas, an emulsion, a salve, a gel, or a drug or some combination of those. It is noted herein that more than one therapeutic agent may be provided to be dispensed by a machine that would perform steps of this process. The agent may be contained in a tank or other reservoir depending on the type of agent. A gas for example might be dispensed from a pressurized tank. A drug might be pumped from a reservoir, and so on. It may be noted that a machine might be adapted or customized to prepare and dispense one or more types of diffusion devices whereby the therapeutic agents in question, more particularly, the tanks and/or reservoirs and delivery apparatus may be part of that customized design.

To charge a diffusion dressing through the charge port installed at step 112 the delivery system engages the port by inserting a needle or other probe into the port and breaks through the uppermost layer of the diffusion device at the base of the port to gain access to the reservoir of the diffusion device. The device may then be filled with agent at step 114. The exact process may vary according to the type of therapeutic agent used and whether or not the agent is pressurized or not and so on. Some of these considerations may dictate the type of engagement architecture used to attach the charge device to the diffusion device including whether or not a port is used.

If a port is used at step 114, the port is sealed after charging at step 115. Sealing the port may be accomplished in an automated fashion by the machine pinching or clamping and heating the port to fuse or close port upon itself. A sealant might be dispensed into the port at the base or at the surface of the port by automated injection from a separate reservoir holding the sealant used. In one embodiment the port might be capped off by placing a cap or material cover over the port and sealing it to the port. In a simple embodiment sealing off the port may be accomplished immediately after injection the therapeutic agent into the device reservoir by the same apparatus.

At step 116 the diffusion dressing may optionally be packaged especially if it will not be used immediately. Packaging may be accomplished via automation by providing a cache of premade pouches large enough to contain the largest diffusion device the machine can dimensionally accommodate. An independent and finished diffusion device may be placed into a pouch via a lever or other mechanical arm and the pouch may then be sealed off or closed to contain the diffusion device. In one embodiment the diffusion device is packaged by overlayment and underlayment of packaging layers which are then peripherally sealed about the device to form the packaged device. In one embodiment no packaging is required because of immediate and local application of the dressing to a patient after dispensing the dressing at step 117. In one embodiment packaging is required to keep the dressing contaminant free between the time of dispense at step 117 and the actual time of application to a patient.

In one embodiment multiple diffusion dressings may be ordered of a same construction and size by denoting the number of devices required at step 108 as described further above. In this embodiment cut lines may be provided in the form of machine perforations along the dimensional boundaries of the device whereby multiple devices are dispensed at one time, the devices linked together serially by the perforations. Other processes performed on the devices are performed with the devices linked or chained together and not separated. After dispensing a number of devices at step 117, the devices may be manually separated from one another simply by pulling them apart at the perforated cut lines.

In one embodiment porting and charging diffusion devices is performed manually at the time of use of the device and not by a dispensing machine. In another embodiment the dressing architecture is sealed at the leading edge and is pre-filled with a therapeutic agent while it is yet housed on a roll or in a container in the machine. The agent may be delivered to the linear dressing through the axle of the roll by attaching the base end of the dressing to the orifice of the therapeutic delivery system and winding the rest of the material about the axle. The act of filling the dressing may be regulated somewhat by the tightness of the winding such that a fully charged architecture is still wound about an axle comprising a roll of charged architecture or can still be folded and placed in a container.

As described above the automated process of preparing and dispensing a diffusion device is supported at least by one or more known machine principles and may include device charging or no device charging. Packaging may or may not be provided and single devices may be produced and dispensed with one order as well as multiple devices produced and dispensed in one order.

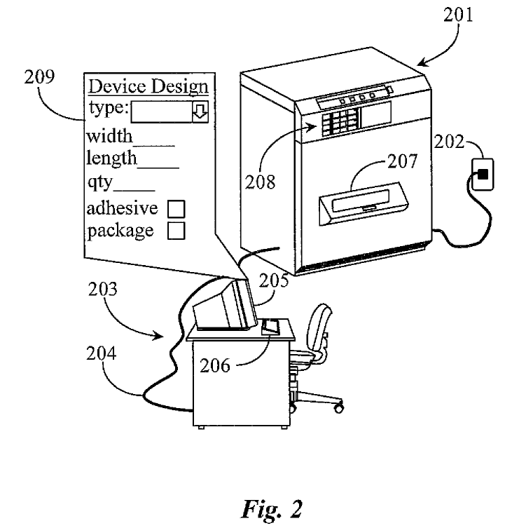

FIG. 2 is a perspective view of a diffusion dressing machine 201 and a connected data input terminal or station 203. Machine 201 may be electrically powered using AC power outlet 202 for a power source. Machine 201 includes a dispensing tray 207 located on the front face of the machine. Finished diffusion dressings may be deposited into tray 207 where they may be retrieved for use. Machine 201 may include a control panel 208 including a variety of controls that may be manipulated such as a power on and off button, a button for pausing the system, a button for starting an order, a button for purging and cleaning a tank or reservoir containing a therapeutic agent, and so on. In one embodiment machine 201 can be operated without terminal 203 by manually operating controls in panel 208.

Terminal 203 includes a data input device, namely a computer keyboard 206 and a computer monitor 205. The input terminal may include a separate processing unit not shown cabled to machine 201 via a data cable 204. A computer desk and chair are illustrated for the convenience of a user. In one embodiment the data input terminal may be built into the machine itself. In this example an electronic order interface 209 is displayed and illustrates various fields for inputting data to design a custom diffusion device. It is noted herein that options may vary according to machine adaptation and functional capabilities. In this example form 209 includes fields for defining device “type”, inputting width and length dimensions, inputting a quantity, and whether adhesive border and packaging will be ordered for a device or devices. In this case the device may or may not be charged when it is dispensed.

In one embodiment a patient record of information may be scanned into machine 201 using a bar code reader or an OCR scanner and some input information might be inferred from the process and would not have to be entered by the practitioner. In one embodiment the processing component keeps records of device ordered for patients that include pertinent information from the patient, practitioner, doctor and so on and the record is linked to other medical record systems thereby enabling accountability, inventory control, and traceability of treatment provided. The number of devices dispensed for a particular patient over time may be deduced enabling quantification of treatment parameters such as how much therapeutic agent was used in a certain period and soon.

Machine 201 may require intermittent maintenance and restocking. For example therapeutic agent may be stored within machine 201 in one or more pressurized tanks and/or reservoirs. Likewise diffusion dressing continuous linear architecture may be stocked in replaceable rolls or packed containers. A machine may include more than one variant of diffusion dressing architecture each “type” loaded in the machine as one of the rolls or in one of the packed containers. The dressing architecture may be pre-sealed and pre-charged with therapeutic agent or it may be void of any therapeutic agent while in a roll or folded within a packed container. In one embodiment devices are built and dispensed without being charged with any therapeutic agent. That process may be performed at the time of use of the device in the patient's room and does not have to be provided by machine 201 in order to practice the invention. However, in one embodiment devices that are dispensed from machine 201 are fully charged and ready for use.

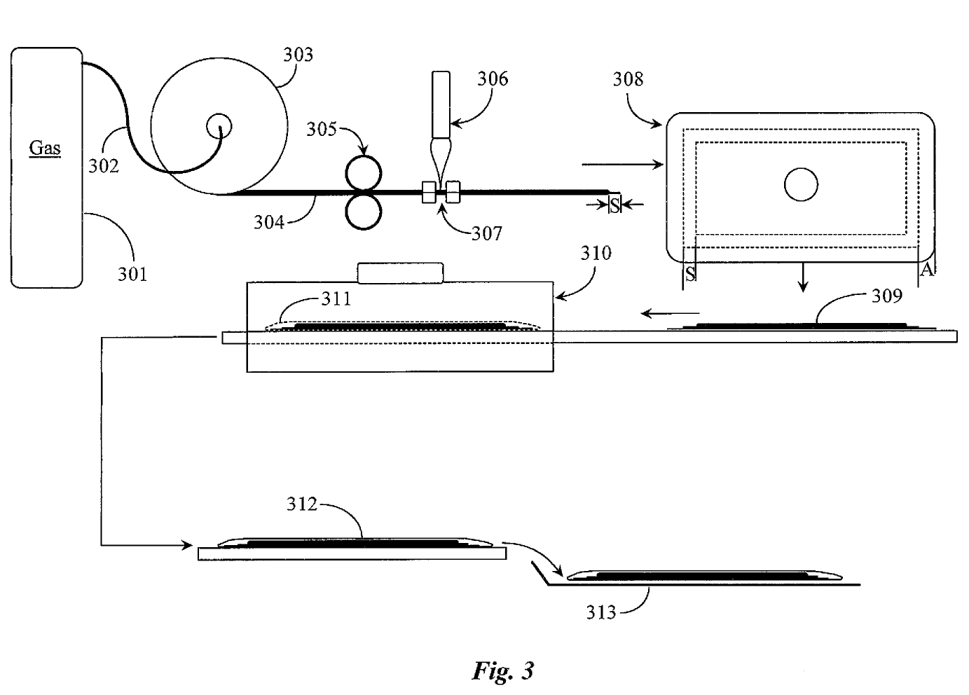

FIG. 3 is a block diagram illustrating logical machine components for fabricating a diffusion dressing according to an embodiment of the invention. In this exemplary portrayal, roll 303 houses a diffusion dressing architecture 304 wound about the axle of the roll. The therapeutic agent is gas in this example and is contained in a pressurized gas tank 301. Tank 301 may be an integral part of the system and maybe refilled or the tank may be replaced with a full tank when necessary. Tank 301 is connected to the axle of roll 303 by a gas delivery hose 302. The axle serves as an orifice for keeping the dressing architecture wound thereabout filled with therapeutic agent. The therapeutic agent may be something different than gas and a reservoir may be part of the system in place of a gas tank. In one embodiment where the agent is stored in a reservoir a pump may be provided to pump the agent into the dressing architecture housed on the roll.

A mechanized set of rollers 305 is illustrated and adapted to advance the dressing architecture off of the roll according to user instruction, for example a cut length of dressing architecture that will make a discrete diffusion dressing. A set of mechanized clamps 307 is provided in this example and adapted to apply pinching pressure to clamp off a section of dressing 304 to prevent any therapeutic agent from leaking out during cutting. Mechanized clamps 307 may also be used to seal the leading and trailing edges of the diffusion device using heat sealing techniques to prevent any leakage of therapeutic agent.

A mechanized cutting tool 306 is provided and adapted to make a cut across the width of the dressing architecture to “part” off a discrete diffusion dressing. The leading edge of the device being parted off by cutting tool 306 is sealed at a length (→|S|←). A border application tool 308 is provided in the form of a stamping tool adapted to apply an adhesive border to the discrete diffusion device illustrated in broken boundary where the peripheral seal (S) of the device is visible. The adhesive border adds a distance (A) around the periphery of the device. The adhesive border may be applied using a roller and blade system instead of a stamping system. The adhesive border may overlap the seal border for any diffusion device. In one case adhesive borders are pre-cut to expected size standards and are applied as needed to devices. The adhesive can be a single piece applied over the entire dressing with a dimension larger than the actual dressing. The adhesive or sticky portion of the border can be exposed peeling off a protective tape or film.

A finished part 309 is filled with therapeutic agent, has sealed edges and an adhesive border for enabling quick application of the device to a patient. In one embodiment a packaging module or tool 310 is provided that enables the device to be automatically packaged for transportation. Tool 310 may station an upper packaging layer and a lower packaging layer, each layer sufficiently longer and wider than the device so as to complete encompass the device. The part may be placed on the lower half of the tool and the upper half containing the upper packaging layer may be brought down over the part to position the packaging layers which may then be sealed together by heating or other method to form a hermetic package 311 that fully encloses the discrete device.

In one embodiment packaging may be accomplished by placing the discrete diffusion device into a pre-prepared pouch and then sealing the open edge of the pouch. In another embodiment mechanized sets of rollers connected to separate rolls of packaging material may be utilized to stretch an upper packaging layer over the top of a diffusion device and a lower packaging layer beneath the diffusion device after which the layers are cut using one or more blade tools and sealed opposing peripheral edges together forming the hermetic packaging.

In this example the hermetically packaged diffusion dressing 312 is pushed into a dispensing tray 313 and is ready for retrieval. In one embodiment no packaging is ordered accept for a diffusion release layer that may be applied to the bottom of the device to prevent any leakage of the therapeutic agent through the diffusion layer of the device. In this case peeling off the bottom layer enables diffusion to begin immediately and the device to be adhered to a tissue area of the patient.

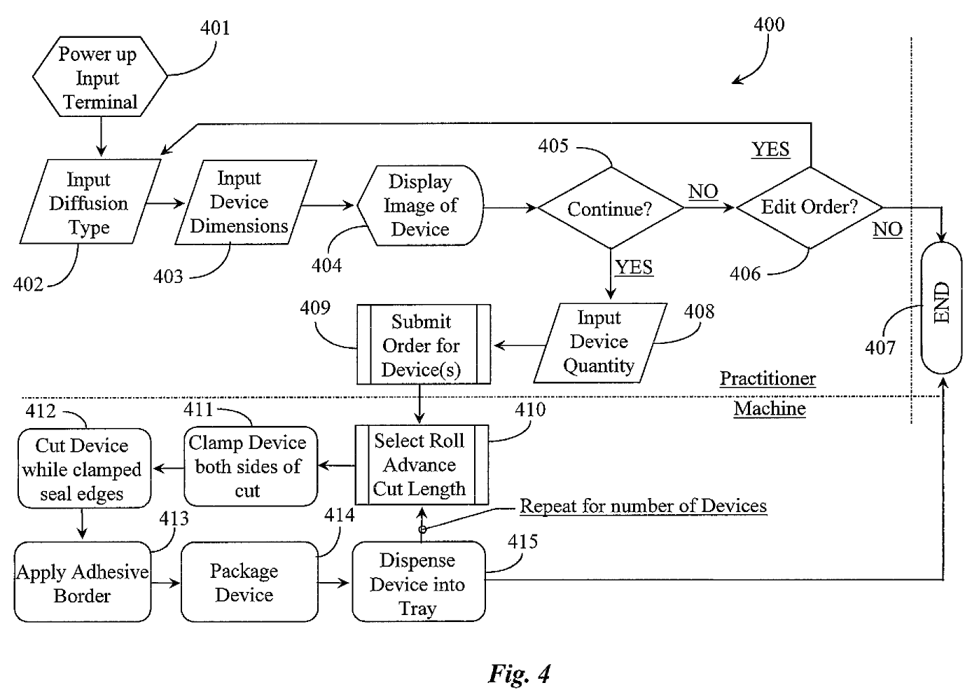

FIG. 4 is a process flow chart illustrating steps 400 for building and dispensing a diffusion device according to another embodiment of the present invention. All of the steps on the practitioner initiation side of the process in this example are identical to the steps on the practitioner side of the process of FIG. 1. Steps 401-409 are identical to steps 101-109 of FIG. 1. The same process variations and alternate possibilities described in FIG. 1 steps 101-109 are applicable in this example relative to steps 401-409.

At step 410 the machine selects the appropriate roll of linear diffusion dressing from which one or more parts will be fabricated. At step 411 the machine clamps the device at both sides of a cut line or the trailing edge of the device. The leading edge was previously clamped and sealed. In this case the dressing may be pre-filled with a therapeutic agent. Therefore clamping the device before cutting is necessary to prevent leakage of the agent. At step 412 the device is cut from the roll of material while the device is clamped and the edges are sealed before the clamps are released. The clamp bars may also be the sealing mechanism in this embodiment.

At step 413 the machine may apply an adhesive border to the device using pre-loaded adhesive rolls and a blade or blades for cutting the borders. In another embodiment the adhesive border may be prefabricated for a standard size of diffusion dressing and may be applied by stamping it one to part. At step 414 the device is packaged using any of the methods and tools previously mentioned above. In one embodiment the device is not packaged but has a peel off release layer that prevents diffusion until the device is ready for use on a patient. At step 415 the device is placed into a tray in a packaged state and is otherwise ready for use. Steps 410 through 415 may be repeated depending on the number of devices ordered. If there is more than one roll used then devices may be fabricated from each of the rolls and may be dispensed accordingly through the initiation of a single order. Of course devices may also be ordered, fabricated and dispensed one device at a time.

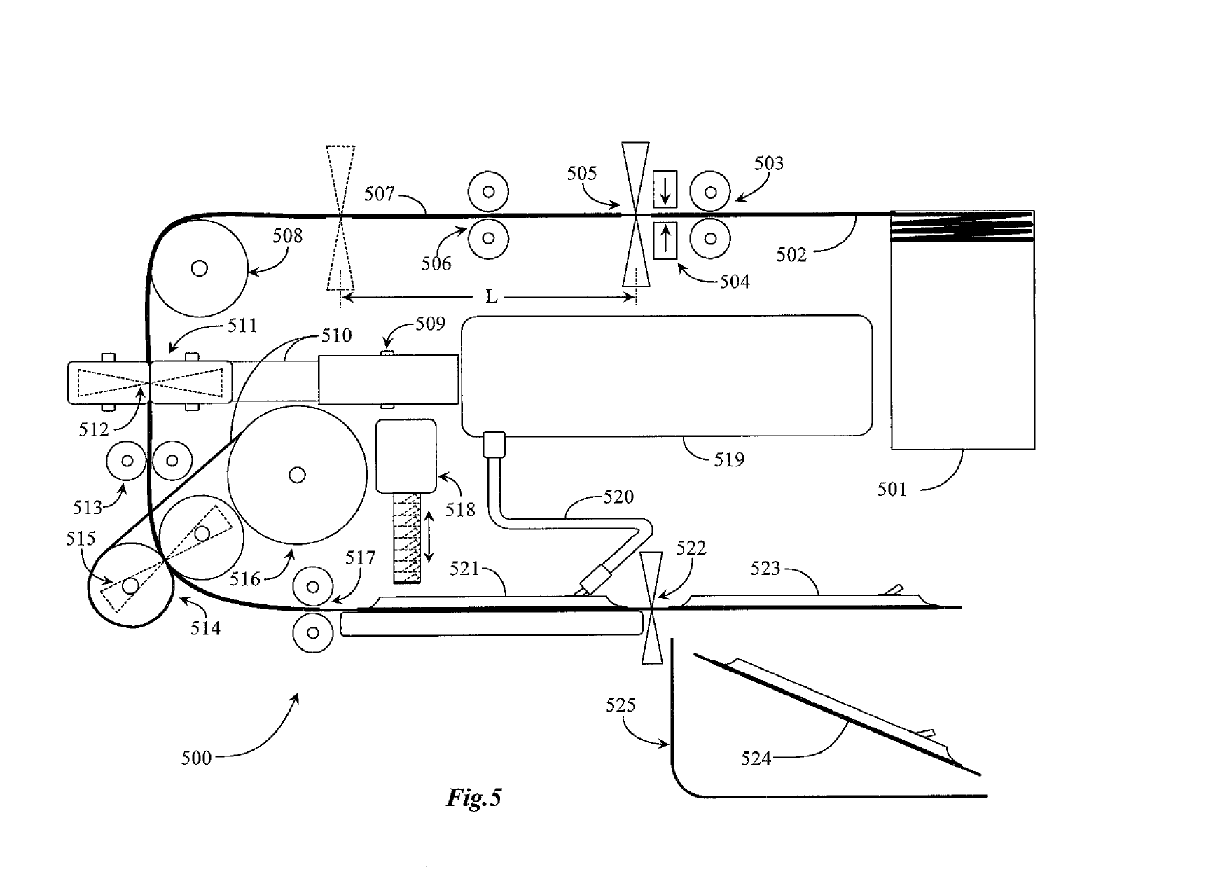

FIG. 5 is a block diagram illustrating logical machine components for fabricating a diffusion dressing according to another embodiment of the invention. In this example a continuous diffusion dressing architecture 502 is housed in a container 501 that presents the material from a folded stack of material. A mechanized set of rollers is provided to advance material 502 for production according to user instruction. A mechanized set of clamps 504 is provided and adapted to form a seal across the width of the material. A set of perforating blades 505 is provided and adapted to create a cut line in the material at the seal but not to completely part off the discrete device. In this case all devices ordered from bin 501 are the same and are standard dimensions. Therefore the machine may make devices available and may have them on hand for immediate dispensing by single part orders or by multiple part orders.

A mechanized set of rollers 506 advances the material. A cut length dimension L is taken from perforation line to perforation line made by perforation tool or blades 505. At this stage the material contains a defined device 507 having length L between the sealed edges (leading edge and trailing edge) and cut-lines (leading perforated edge and trailing perforated edge) but is still not actually separated into discrete devices.

A mechanized roller 508 advanced the material for application of an adhesive border to the sealed surface. A mechanized tape dispenser 511 is connected to a roll of adhesive tape 509. Tape dispenser 511 includes opposing mechanized rollers and a cutting tool 512. Dispenser 512 applies double sided adhesive tape to the underside of the device over the sealed portion of the device so as to provide adhesive to the edges of two devices simultaneously. The tape may be perforated to align correctly with the perforations made in the material that determine the individual devices. In this case dispenser 511 does not apply adhesive to the linear edges but only to the edges connected together by perforation.

A mechanized set of rollers advances the material to a second adhesive tape dispenser 514 connected to a roll of adhesive tape 516. Dispenser 514 includes a set of mechanized rollers and a cutting tool or blades 515. In one embodiment a dispenser and associated mechanics (rollers and cutting blades) is provided one for each side of the diffusion device. Tape is applied to the undersides of the linear edges of the diffusion device. In this way an adhesive border may be applied to the diffusion device before breaking separating a device from other devices by compromising the perforation line.

In this example ports for charging a diffusion device are installed on the devices for the purpose of charging the devices onboard the machine. A mechanized roller set 517 advances the material for charge port installation. A charge port installation tool 518 is provided and adapted to install one charge port per device by dispensing a charge port and pressing the port onto the top layer of material of the diffusion device. The charge port comprises an annular tube formed to an adhesive pad in one embodiment. The adhesive pad provides the installation support for the port.

A tank or reservoir 519 is provided in this example and is adapted to contain and to deliver a therapeutic agent for charging each diffusion device. Tank 519 includes a rigid or semi-rigid and mechanized delivery line 520 that can be caused to mechanically engage the installed port on a diffusion device. This may occur by maneuvering the device material or by maneuvering the delivery line or by a combination of the two. To charge a diffusion device with therapeutic agent through a charge port, the top layer of material under the port must be punctured to enable contact with the reservoir space of the device. As the delivery line head engages the port a needle or other sharp utensil (not illustrated) may be provided to puncture the layer allowing therapeutic agent to enter the device.

Device 521 is a charged diffusion device not yet removed or separated from other devices in the material chain. After charging device 521 the same mechanized agent delivery line may be used to seal off the port by injecting a sealant from another reservoir or by collapsing the port onto itself and heating the material until a seal is formed. Other methods are possible and are supported by machine principle. A set of cutting blades 522 may be provided at the end of the device path for cutting off a device for dispensing into a dispense tray 525. In this case a completed device 524 is in the tray and a second identical device 523 is about to enter the tray while device 522 is being charged and sealed before advancing to tray 525. A machine may have a number of dispensing trays and device machine paths to accommodate different device architectures and dimensions without departing from the spirit and scope of the present invention.

On one embodiment a user may order just one of diffusion device “A” used for healing burns. A standard size selection of small medium and large may be offered selection of which determines the machines choice of raw materials to advance for production. In this example parts that are standardized may already be fabricated within the machine and are ready to dispense such that placing an order results in immediate dispense of the ordered device or devices. The machine may advance material and continue processing on its own between orders to accommodate for the product dispensed. In one embodiment the device is ejected but still connected by perforated edge to the device behind it and the user must tear the device off at the perforation line. If two parts are ordered then the material advances the length of two parts out of the machine and the user may tear the two parts off at the perforation line but keep the two parts connected together via the perforation line between the two until one of the devices is needed.

It will be apparent to one with skill in serial mechanical processing that steps can be modified according to need or design without departing from the spirit and scope of the present invention. For example a charge port may be installed and the device may be charged later in a latter stage of processing. In another embodiment the device material is pre-sealed and pre-charged before processing and no charge port is required. In still other embodiments other design processes may be enabled without departing from the spirit and scope of the invention. For example a machine may be provided that is further to capable of assimilating raw material layers that would be arranged in order by the machine to make a diffusion dressing including bottom diffusion dressing top and packaging layers. In a preferred embodiment however some standardization exists regarding makeup and function of certain diffusion dressings used for specific tissue conditions.

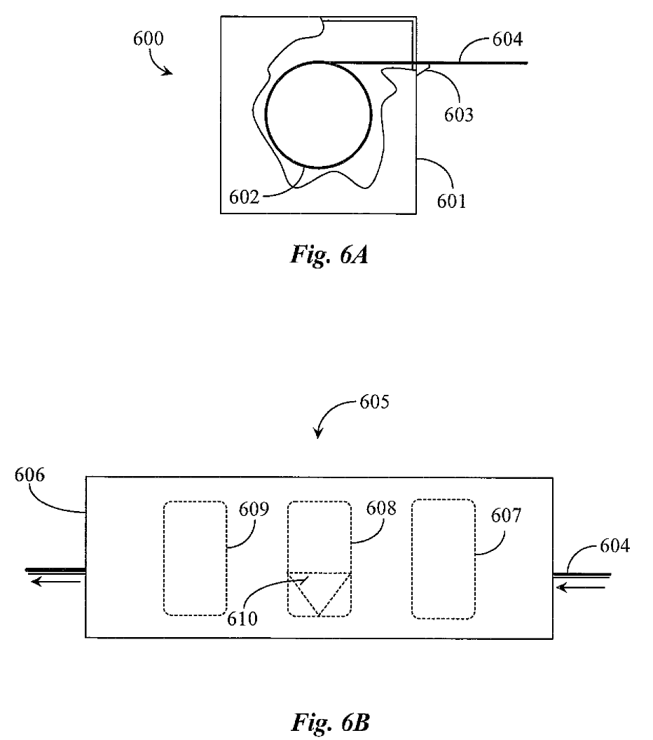

FIG. 6A is a block diagram logically illustrating a single manually operated dressing dispenser 600 according to another embodiment of the present invention. Dressing dispenser 600 is a manual dispenser in this example and includes a dressing roll 602 where the dressing 604 is wrapped around an axle to form the roll and where the roll is contained in a machine housing 601 with the leading edge of the dressing 604 made available externally from the housing for manual dispensing of any length of dressing. In this case there is no automation for dispensing the material. The leading edge in pulled. A cutting edge 603 is provided for manually cutting a length of dressing. In one embodiment a user may with a pair of scissors cut the dressing off at a length and then may shape the dressing accordingly. In this embodiment the dressing is not filled with any therapeutic agent.

FIG. 6B is a block diagram logically illustrating an automated charging and sealing station 608 for finishing a diffusion dressing cut from the dispenser of FIG. 6B. Dressing 604 from FIG. 6B may be fed into an entry port in station 605 in the direction of the arrow. The dressing may then be fed into a charging station 607 where the dressing may be filled with a therapeutic agent in a number of different ways described further above. The dressing 604 may then proceed to a module 608 where an adhesive border or adhesive sheet may be applied and optionally this module may include an optical system 610 for determining the size of the dressing in order to pre-select adhesive from the proper roll. A scanner or a camera may be used.

Although not illustrated in this example, but described in the example of FIG. 2 above, a computer interface might be provided that enables the use to determine a type of therapeutic agent, the type of adhesive used and the type of packaging used. The dressing may then be sent to a module 609 where the dressing may be packaged. At the end of processing the finished device may exit the station 605 in the direction of the arrow through an exit port to be received in a tray for pickup. The device is charged and packaged.

It will be apparent to one with skill in the art that the system for building and dispensing diffusion dressings of the invention may be provided using some or all of the mentioned features and components without departing from the spirit and scope of the present invention. It will also be apparent to the skilled artisan that the embodiments described above are exemplary of inventions that may have far greater scope than any of the singular descriptions. There may be many alterations made in the descriptions without departing from the spirit and scope of the present invention.

What is claimed is:

1. A method supported by machine automation for fulfilling a request for a diffusion dressing comprising the steps:
(a) translating the request into a set of machine readable instructions the translation performed by the machine receiving the request;
(b) equating the commands in the machine instruction set to a build sequence known to the machine that received the request;
(c) executing the build sequence to create the diffusion dressing; and
(d) dispensing the diffusion dressing from the machine.

2. The method of claim 1 wherein the request is entered into the machine as digital input.

3. The method of claim 1 wherein the diffusion dressing includes a top layer, a reservoir, and a diffusion layer the reservoir located between the layers.

4. The method of claim 1 wherein in step (a) the request is received through a keyboard and monitor interface.

5. The method of claim 1 wherein in step (a) the machine readable instructions include X and Y dimensioning.

6. The method of claim 1 wherein in step (b) the build sequence includes a step for cutting a length X of dressing from a roll of dressing of width Y, X and Y specified in the request.

7. The method of claim 6 wherein in step (b) the build sequence includes a step for packaging the diffusion dressing.

8. The method of claim 6 wherein in step (b) the build sequence includes a step for filling the diffusion dressing with a therapeutic agent.

9. The method of claim 1 wherein steps (c) and (d) are repeated in sequence for a number of diffusion devices ordered of the same type and properties.

10. The method of claim 6 wherein in step (b) the build sequence includes a step for applying an adhesive border.

11. The method of claim 9 wherein the dispensed diffusion dressings are linked together by a perforated section.

12. A computerized system for preparing and dispensing diffusion dressings according to instruction data input into the system comprising:
a computerized platform for inputting information;
one or more material stations for housing raw materials;
at least one set of mechanized rollers for advancing material;
at least one set of material cutters for cutting material;
a mechanized edge sealer for sealing material edges; and
an externally accessible repository for dispensing finished dressings.

13. The system of claim 12 wherein the computerized platform includes a graphics monitor, a keyboard, and a processing component.

14. The system of claim 12 wherein the computerized platform includes an optical character recognition (OCR) scanner or a bar code reader.

15. The system of claim 12 wherein the one or more material stations is an axle supporting a roll of material.

16. The system of claim 12 wherein the one or more material stations is a bin containing material stacked in folds.

17. The system of claim 12 further including at least one delivery system and reservoir for storing and delivering a therapeutic agent.

18. The system of claim 17 wherein the reservoir is a pressurized tank and the therapeutic agent is a gas.

19. The system of claim 17 wherein the delivery system includes a pump and the therapeutic agent is a liquid.

20. The system of claim of claim 17 further including a mechanized cartridge for installing charge ports.

21. The system of claim 12 further including at least one mechanized tape dispenser for applying an adhesive border to the diffusion device.

22. The system of claim 12 wherein the edge sealer operates by heating material edges to form the seal.

23. The system of claim 12 wherein the edge sealer dispenses epoxy or adhesive strip to seal the edge.

24. The system of claim 12 further including a mechanized dressing packager for hermetically packaging the dressing.

25. The system of claim 24 wherein the packager places the device on a packing layer of a size footprint larger than the footprint of the dressing and an overlays the dressing with another packing layer of similar dimension and seals the layers together peripherally.

26. The system of claim 24 wherein the packager places the dressing into a pre-prepared pouch and then seals the pouch.

27. A method for preparation of an empty diffusion dressing comprising the steps:
(a) manually cutting or shaping a diffusion dressing from dimensionally larger stock; and
(b) using automated machine principles, tailoring properties of diffusion device according to need.

28. A system for preparing an empty diffusion device cut or otherwise shaped to a finish size comprising:
a mechanized conveyor to accept at an input port and then dispense into an output tray customized dressings;
a computerized data entry interface including a form or template for entering packaging, adhesive, and therapeutic agent parameters;
a station including delivery system for charging the diffusion dressing with a therapeutic agent;
a station including an adhesive applicator for applying adhesive to the diffusion dressing; and
a station including a packaging arm for packaging the diffusion device into a sterile pouch for transport.
